(19) United States
(12) Patent Application Publication
(10) Pub. No.: US 2002/0194144 A1
(43) Pub. Date: Dec. 19, 2002

(54) Method and system for collecting recyclable waste

(76) Inventor: Matthew P. Berry, Columbus, OH (US)

Correspondence Address: Robert R. Lech, Esq., Arter & Hadden LLP, One Columbus, 10 West Broad Street, Suite 2100, Columbus, OH, 43215-3422, US

(21) Appl. No.: 09/867,858

(22) Filed: May 30, 2001

(51) Int. Cl. G06F 17/00

(52) U.S. Cl. 705/414

(57) ABSTRACT

A method for billing a customer for waste collection. The method includes the step of identifying an amount of recyclable waste. The method also includes the step of determining a credit amount based on the amount of recyclable waste. The method further includes the step of reporting the credit amount to the customer. A container for use in a recycling system is also described. The container includes a structure for containing recyclable waste; and an indicia disposed on the structure. The indicia identifies the value of the recyclable waste contained by the structure.

### TECHNICAL FIELD

The described system and method are generally related to separating solid materials and assorting or segregating them in grades or classes according to physical characteristics. More specifically, the described method and system relate to segregating recyclable materials into readily identifiable units.

### BACKGROUND OF THE INVENTION

Recycling household and commercial waste has a number of benefits. Recycling conserves natural resources by substituting “secondary resources”, including paper, glass and metal for original natural resources. It also extends the useful life of landfills which would otherwise contain materials that could be productively reused.

According to the U.S. Environmental Protection Agency (“EPA”), in the early 1980's only one curbside recycling program was operating in the United States. By 1997, more than 9,000 curbside programs were operating, and there were more than 12,000 recyclable drop-off centers nationwide. Further, 380 materials recovery facilities were in operation by 1997 to process the collected materials.

Despite voluntary, community-based recycling programs, and despite the nation's general awareness of recycling and its benefits, many households and businesses fail to recycle, or recycle only a fraction of their potentially recyclable waste. This failure to adequately recycle is an increasing problem because the United States produces vast amounts of trash. According to the EPA, in 1997 the U.S. generated 217 million tons of municipal solid waste (“MSW”). In human terms, the average person generated 4.3 pounds of trash per day. That represents a 138% increase from 1960 at which time each person generated an average of 2.7 pounds, an increase of 5.11% per year.

Approximately 55% of all MSW is land-filled, with 2,514 landfills operating across the country on a daily basis. 17% of all MSW is incinerated. The remaining 27% is recycled. Between 1990 and 1995, recycling increased a total of 20% or 3.33% per year, mostly due to the increased number of community curbside recycling programs.

Such increases, however, have been outstripped by the shear increase in MSW. The ever-expanding economy continues to drive the purchase of more and more packaged goods and services. Thus, for 1997 there continued to be a net loss to disposal versus recycling of 1.78%. In other words, it is expected that regardless of all of the community-based efforts, the U.S. national MSW output will continue to increase approximately 1.78% per year. While recycling efforts to date have slowed the expansion of MSW, the trash problem continues to grow.

Consequently, a need exists for an improved method and system for recycling waste that encourages increased household and business participation in a recycling program. A need further exists for an improved method and system for recycling waste that financially rewards recycling participation. Yet another need exists for an improved method and system that enables identification, trading and selling of collected bundles of recyclable waste.

### SUMMARY OF THE INVENTION

According to a first aspect of the present invention, a method for billing a customer for trash collection is described. The method includes the step of identifying an amount of recyclable. The method also includes the step of determining a credit amount based on the amount of recyclable waste. The method further includes the step of reporting the credit amount to the customer.

According to a second aspect of the present invention, a container is described for use in a recycling system. The container comprises a structure for containing recyclable waste. The container further comprises an indicia disposed on the structure. The indicia identifies the value of recyclable waste which may be contained within the structure.

According to a third aspect of the present invention, an apparatus is disclosed for billing a consumer for trash collection. The apparatus comprises a processor and a memory. The processor and memory are connected, and the memory stores a program to control the operation of the processor. The processor is operative with the program in the memory to receive a first amount representing an amount of trash identified as non-recyclable. The processor is further operative with the program in the memory to receive a second amount representing an amount of trash identified as recyclable. The processor is still further operative with the program in the memory to apply a charge based on the first amount and apply a credit based on the second amount. The processor then reports the charge and credit to the customer for payment or credit according to the program in the memory.

According to a fourth aspect of the present invention, a computer-readable storage medium is described. The medium is encoded with processing instructions for implementing method for billing a consumer for trash collection. The processing instructions direct a computer to determine a first amount representing an amount of trash identified as non-recyclable. The processing instructions also direct a computer to determine a second amount representing an amount of trash identified as recyclable. The program instructions further direct a computer to apply a charge based on the first amount and apply a credit based on the second amount. The program instructions finally direct a computer to report the charge and credit to the customer for payment or credit.

The objects, features and advantages of the disclosed method and system are readily apparent from the following description of the preferred embodiments when taken in connection with the accompanying drawings.

### BRIEF DESCRIPTION OF THE DRAWINGS

For a more complete understanding of the disclosed method and system and the advantages thereof, reference is now made to the following description taken in conjunction with the accompanying drawings in which like reference numbers indicate like features and wherein:

FIG. 1 is a schematic block diagram illustrating the environment of an embodiment of the described method and system;

FIG. 2 is a pictorial view of the point of collection in one embodiment of the present invention; and

FIG. 3 is a functional flow diagram illustrating the primary steps employed according to the method of the present invention.

### DETAILED DESCRIPTION

Recycling Environment

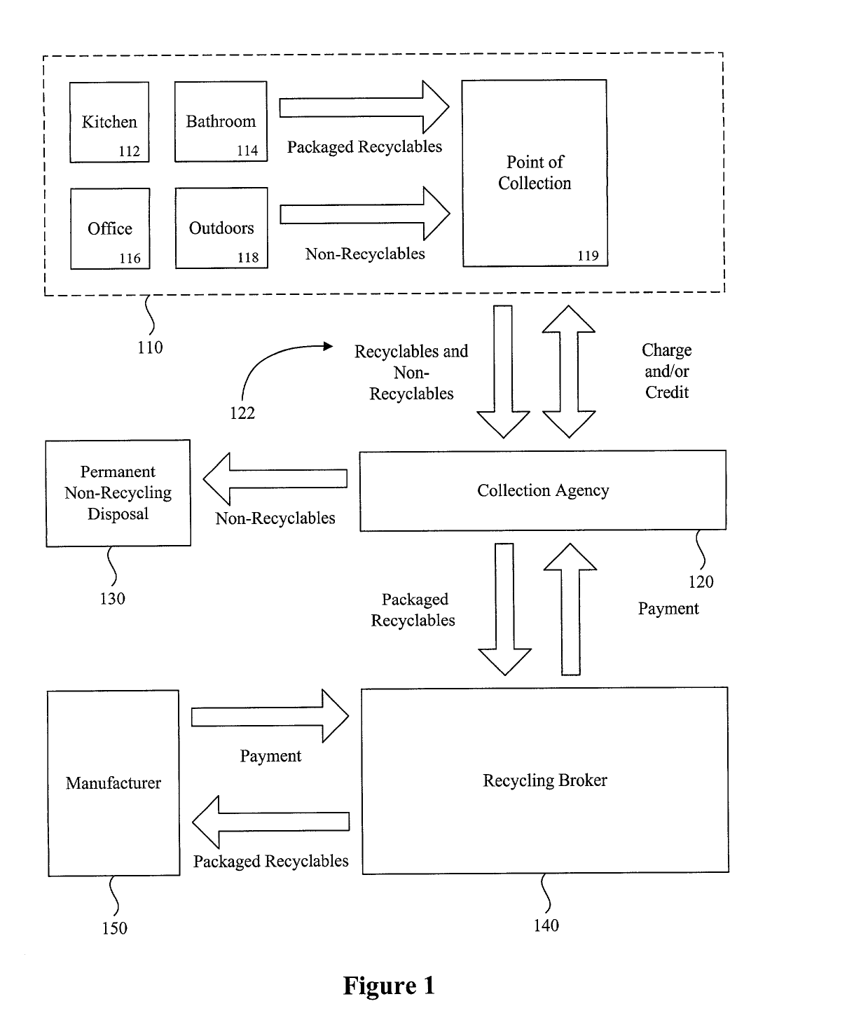

Referring to FIG. 1, there is block diagram illustrating the environment of a preferred embodiment of the described method and system. In the example shown in FIG. 1, a household 110 is depicted as a waste generating entity. Of course, household 110 is merely one example of an entity that generates waste which may be disposed of using the method and system of the present invention. Other waste generating entities that could benefit from the present invention include, for example, business offices, manufacturers, retailers and restaurants.

Household 110 includes a number of points of disposal. A point of disposal is a location at which waste is generated, particularly recyclable waste. A point of disposal is the first point at which waste is handled in accordance with the present invention. Points of disposal within household 110 include the kitchen 112, the bathroom 114, the office 116 and outdoor areas 118 such as the garage and the yard. Of course, these points of disposal are merely illustrative.

According to the preferred embodiment, waste is sorted and packaged at each point of disposal and transported to a point of collection 119. Although in the preferred embodiment waste is transported directly between the points of disposal 112, 114, 116 and 118 and the point of collection 119, in an alternate embodiment there may be one or more intermediate points of storage (not illustrated) at which waste is stored prior to collection. Non-recyclable waste may be packaged in a conventional manner. Recyclable waste, such as paper, metal, glass, plastic and toxic materials, for example, are packaged into readily identifiable units. For purposes of this description, recyclable waste may be grouped into units known as “Complete Unit of Recyclable” (hereafter referred to as a “CUR”, pronounced “CURE”).

A CUR is a unit of measuring the value of a particular recyclable. By bundling recyclable waste into readily identifiable, sorted, measured groups, each bundle of recyclable waste may move efficiently and productively through a stream of recycling. The stream of recycling includes a series of sequential points through which all recycled goods must travel in order to be recycled. The first point in the stream is the point of disposal 112, 114, 116 and 118. The second is the point of collection 119. The third is the point of exchange, and the fourth is the point of reuse.

The point of collection 119 for household 110 is generally a “curb-side” pickup point. Of course, any location accessible to the collection agency 120 will suffice, including, for example, a garage, a shed, an alley or a dumpster. In the preferred embodiment, representatives of collection agency 120 travel to the point of collection 122, typically in a truck, and remove the disposed waste to be recycled or permanently disposed.

Collection agency 120 transports items that have not been identified as recyclable to a point of permanent non-recycling disposal 130. Typically, the point of permanent disposal is a land fill or incinerator.

Collection agency 120 transports the packaged recyclables to a point of exchange 122. At the point of exchange, the packaged recyclables are traded for payment instead of being land-filled or burned. At this point, a buyer and a seller meet to trade in CURs. For example, collection agency may have gathered several yellow 1-CUR bags of plastic at their originating points of collection 119. Collection agency 120 may market them to a recycler or recycling broker 140.

In turn, recycling broker 140 markets the packaged recyclables to a manufacturer 150 to be converted for use into new products. At this point or reuse, units of CURs are recycled into other products that are then sold in other markets.

CUR Containers

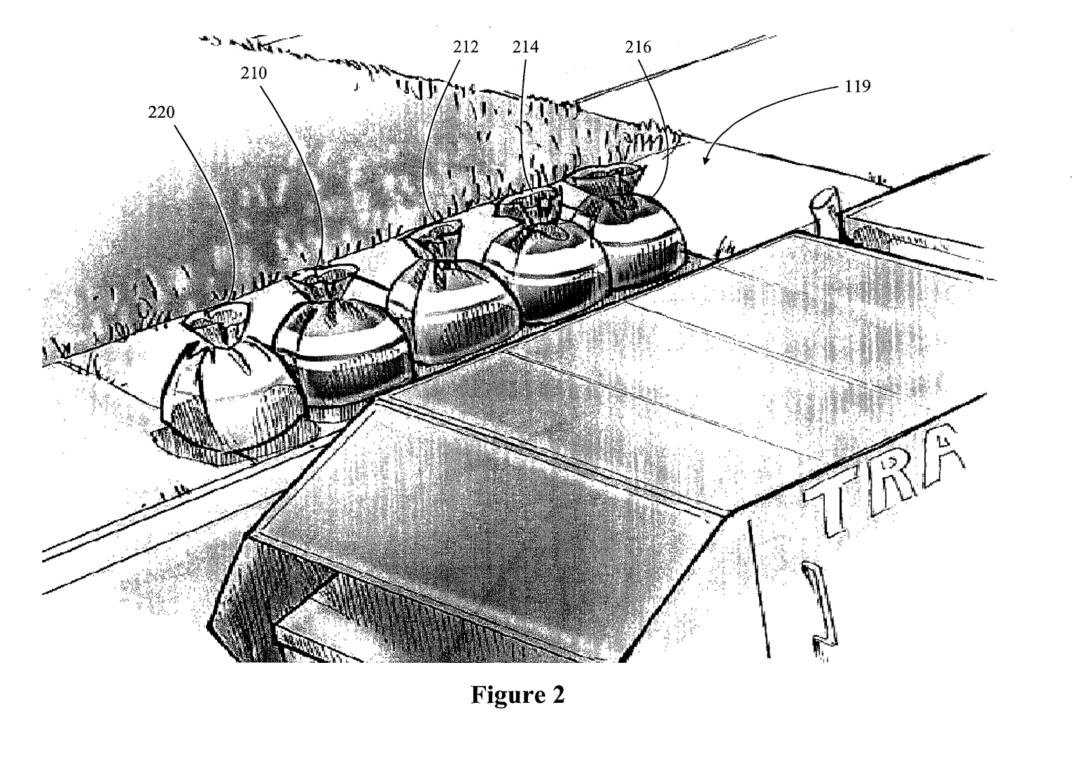

Referring now to FIG. 2, there is illustrated a pictorial view of the preferred point of collection 119. As shown, preferred point of collection 119 is a curb-side location. The preferred containers of the present invention are also illustrated. The illustrated point of collection 119 includes a bag of recyclable plastic 210, a bag of recyclable metal 212, a bag of recyclable glass 214, a bag of recyclable paper 216 and two bags of unidentified waste 220.

In accordance with the present invention, each container of recyclable waste includes certain characteristics. Namely, each container of recyclable waste includes indicia that enables one to readily identify the contents and the value of the container relative to other recyclable products. As previously described, the preferred means for identifying the relative value of recyclables is using CUR's, a specialized unit of measurement that is effectively a currency that allows for trading of recyclables.

Although the preferred content and value identification means is a written indicia of the material type and number of CUR's contained within a container, there are numerous other means for accomplishing this. For example, every type recyclable material and value could be represented by a different color, as illustrated in Tables A and B, below.

TABLE A
Recyclable Materials Table

| RECYCLABLE MATERIAL | COLOR INDICATOR |
|---|---|
| Plastic | Red |
| Metal | Green |
| Glass | Blue |
| Paper | Yellow |
| Toxic Materials | Black |
| Yard Waste | Brown |

TABLE B
CUR Value Table

| CUR VALUE | COLOR INDICATOR |
|---|---|
| 0.10 CUR | White |
| 0.25 CUR | Pink |
| 0.50 CUR | Purple |
| 0.75 CUR | Orange |
| 1.00 CUR | Light Blue |

Using the examples set forth in Tables A and B, an identification system could be fashioned using the color of bags to denote the contents and the color of a stripe on a bag to denote a CUR value. For example, a red bag with a white stripe would contain 0.10 CUR worth of recyclable plastic. Following the same example, a blue bag with a light blue stripe would contain 1 CUR of recyclable glass.

Other examples of means for indicating the contents and relative value of a bag of recyclables include, for example, barcoded material and value information, informational stickers applied to a container, symbols representing recyclable materials and/or values. Of course, the present invention includes any convention identification means.

The use of barcoded or other electronically readable indicia enables a collection agent to automatically bill a consumer for trash collection using a computerized apparatus. Such an apparatus enables a collection agent to identify or electronically read an amount of non-recyclable trash and an amount of recyclable trash. A processor within the apparatus then applies charges and credits according to the amounts entered or electronically read. The apparatus could then report the change and credit to the consumer for payment or credit.

Preferably, users collect recyclable material at various points of disposal within a household or business. Users place appropriate containers, identifying the material and the value of a full container at each point of disposal. In addition to readily identifying the contents and value, the containers of the present invention are preferably made from the recyclable material that they contain, to the extent commercially reasonable. This allow primary and secondary markets to value them by their approximate weight, an approximation of which is readily available by their individual appearance.

Consequently, the containers of the present invention have some characteristic that promotes future redeemability. Each container:

Enables identification of the contents;

Enables identification of a relative value;

Promotes a market valuation;

Enables identification of an approximate weight (either explicitly or based on value);

Is itself recyclable, where commercially practicable; and

Promotes efficient future redemption.

CUR Collection Method

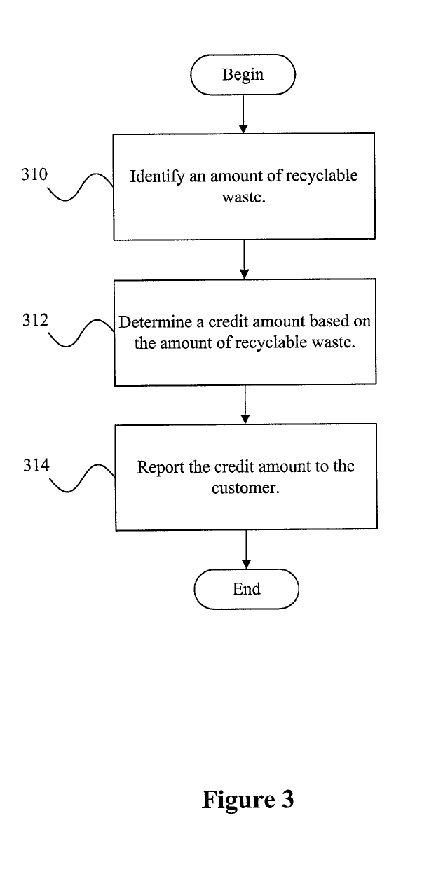

Referring now to FIG. 3, there is illustrated a functional flow diagram illustrating the primary steps employed according to preferred method of the present invention. The steps of the method are typically performed by a representative of collection agency 120 at the point of collection 119.

According to step 310, an amount of recyclable waste is identified. Preferably, the amount of recyclable waste is identified according to the indicia on each container of recyclable waste. Of course, other forms of identification are possible, such as weighing the amount of each type of recyclable waste, including for example, glass, plastic, metal and paper.

At step 312, a credit amount is determined based on the amount identified at step 310. Preferably, the credit amount is determined based on a number of CURs of recyclable waste, regardless of the type of material. Of course, the credit amount could be determined in a number of ways, such as, for example, by applying a different value to each type of recyclable material, and applying each different value to specific weights identified at step 310.

At step 314, the credit amount determined at step 312 is reported to the customer. Preferably, the credit amount is reported to the customer in connection with applying the credit to a financial account on the customer's behalf. In one embodiment, the credit is reported as an offset to a collection charge for the services of collection agency 120.

Practical Advantages of the Invention

An advantage of the present invention is that it addresses a previously unrecognized reason that trash production continues to grow faster than present recycling efforts. Namely, trash production is perceived to be free and recycling is considered to be an expense. Producing and disposing of a product or packaging is not considered a cost to the purchaser. The cost is neither implicitly imposed, such as through higher product costs. Nor is the cost explicitly imposed, such as through disposal fees.

Although a portion of municipal taxes are used for local trash services and businesses are charged for their production, the typical consumer perceives no direct correlation between the disposal of a package and the cost of such disposal. Consequently, there is no incentive for a consumer to recycle, and there is no disincentive for a consumer to permanently dispose of waste. The absence of market forces from the disposal decision causes increased MSW compared with recycling efforts.

The method and system of the present invention reduces MSW production and increases recycling by financially encouraging consumers to recycle and preferably financially discouraging consumers to permanently dispose of waste. Consequently, use of the present invention results in decreased permanent disposal and increased recycling.

Another advantage of the present invention is that it encourages the reduction of the cost of waste removal. Yet another advantage of the present invention is that it encourages more complete recycling than prior art recycling methods and systems.

From the above description, those skilled in the art will perceive improvements, changes and modifications in the disclosed method and system. Such improvements, changes and modifications within the skill of the art are intended to be covered by the appended claims.

Accordingly, it is to be understood that the drawings and description in this disclosure are at proffered to facilitate comprehension of the disclosed method and system, and should not be construed to limit the scope thereof. It should be understood that various changes, substitutions and alterations can be made without departing from the spirit and scope of the disclosed method and system as defined solely by the appended claims.

What is claimed is:

1. A method for billing a customer for waste collection, comprising:
identifying an amount of recyclable waste;
determining a credit amount based on the amount of recyclable waste; and
reporting the credit amount to the customer.

2. A method according to claim 1 wherein the step of identifying includes identifying a weight.

3. A method according to claim 1 wherein the step of identifying is performed based on an indicia on a container.

4. A method according to claim 3 wherein the indicia represents an approximate weight of the contents of the container.

5. A method according to claim 3 wherein the indicia identifies the recyclable material in the container.

6. A method according to claim 3 wherein the indicia identifies an approximate value of the contents of the container.

7. A method according to claim 1 further comprising:
identifying an amount of non-recyclable waste;
determining a charge amount based on the amount of non-recyclable waste; and
reporting the charge amount to the customer.

8. A method according to claim 7 wherein the step of identifying an amount of non-recyclable waste includes identifying a weight.

9. A method according to claim 7 wherein the step of reporting includes reporting an aggregate of the charge amount and the credit amount.

10. A container for use in a recycling system, comprising:
a structure for containing recyclable waste; and
indicia disposed on the structure, the indicia identifying the value of the recyclable waste contained by the structure.

11. The container according to claim 10 wherein the indicia identifies the value by identifying a material type and a weight.

12. The container according to claim 10 wherein the indicia is a color.

13. The container according to 10 wherein the indicia is a sticker applied to an outer surface of the structure.

14. The container according to 10 wherein the indicia is a symbol printed on an outer surface of the structure.

15. The container according to claim 10 wherein the structure comprises the same class of material as the recyclable waste.

16. An apparatus for billing a consumer for trash collection, comprising:
a processor;
a memory connected to said processor storing a program to control the operation of said processor;
the processor operative with the program in the memory to:
receive a first amount representing an amount of trash identified as non-recyclable;
receive a second amount representing an amount of trash identified as recyclable;
apply a charge based on the first amount;
apply a credit based on the second amount; and
report the charge and credit to the customer for payment or credit.

17. An apparatus according to claim 16 wherein the first amount is a weight.

18. An apparatus according to claim 16 wherein the second amount is a weight.

19. An apparatus according to claim 16 wherein the second amount is determined based on an indicia on a container.

20. An apparatus according to claim 19 wherein the indicia identifies the recyclable material in the container.

21. An apparatus according to claim 19 wherein the indicia identifies an approximate value of the contents of the container.

22. An apparatus according to claim 16 wherein the step of reporting includes reporting an aggregate of the charge and the credit.

23. A computer-readable storage medium encoded with processing instructions for implementing method for billing a consumer for trash collection, the processing instructions for directing a computer to perform the steps of:
determining a first amount representing an amount of trash identified as non-recyclable;
determining a second amount representing an amount of trash identified as recyclable;
applying a charge based on the first amount;
applying a credit based on the second amount; and
reporting the charge and credit to the customer for payment or credit.
